(19) United States
(12) Patent Application Publication
(10) Pub. No.: US 2005/0125461 A1
(43) Pub. Date: Jun. 9, 2005

(54) Version control of metadata

(75) Inventor: Frank S. Filz, Beaverton, OR (US)

Correspondence Address: LIEBERMAN & BRANDSDORFER, LLC, 12221 MCDONALD CHAPEL DRIVE, GAITHERSBURG, MD, 20878, US

(73) Assignee: International Business Machines Corporation, Armonk, NY (US)

(21) Appl. No.: 10/730,576

(22) Filed: Dec. 8, 2003

(51) Int. Cl. G06F 12/00

(52) U.S. Cl. 707/203

(57) ABSTRACT

A method and system for efficiently determining compatibility between a server node and a shared resource. The system includes a version control record that organizes metadata relating to the cluster and to data within the shared resource into a searchable format. A server node joining the cluster accesses the version control record at a known location (102). Prior to joining the cluster, the server node will use the version control record to determine compatibility with the disk header version (104), compatibility with the control record version (110), and compatibility with each data item in the version control record (112). In addition, the system may be used as a control mechanism for upgrades to system resources for existing cluster members.

### BACKGROUND OF THE INVENTION

1. Technical Field

The present invention relates to compatibility between a server node and a shared resource. More specifically, the invention relates to a method and system to efficiently determine compatibility of the server node and the shared resource prior to cluster membership.

2. Description of the Prior Art

A node could include a computer running single or multiple operating system instances. Each node in a computing environment includes a network interface that enables the node to communicate in a local area network. A cluster includes a set of one or more nodes coordinating access to a set of shared storage subsystems typically through a storage area network. The shared storage subsystem may include a plurality of storage media. FIG. 1 is a diagram (10) of a typical cluster (12) of server nodes in communication with a storage area network. There are three server nodes (14), (16), and (18) shown in the cluster (12). Server nodes (14), (16), and (18) may also be referred to as the members of the cluster (12). Each of the server nodes (14), (16), and (18) are in communication with the storage area network (20). The storage area network (20) may include a plurality of storage media (22), (24), and (26), all or some which may be partitioned to the cluster (12). Each member of the cluster (14), (16) or (18) may obtain reading and/or writing privileges with respect to the storage media assigned to the cluster (12). Accordingly, in a cluster environment each member of the cluster may request access to data within the shared storage subsystem assigned to the cluster.

Prior to joining a cluster, it is important for the node to determine it's compatibility with other members of the cluster, as well as compatibility with data stored in the storage subsystem. For example, it is known in the art to conduct upgrades to software operating on a server, as well as converting data to ensure compatibility with the upgrade of the software. Prior art systems allow server nodes to join the cluster prior to determining software compatibility between the software operating on the joining server and data stored within an area of the storage area network assigned to the cluster. FIG. 2 is a flow chart (50) illustrating an example of a process of a new server node joining a cluster without a mechanism for prior verification of compatibility. The new server node accesses the master disk of the storage area network (52). Thereafter, a test is conducted to determine if the disk header of the master disk is compatible with the new server node (54). A negative response to the test at step (54) will result in the new server node being incompatible with the master disk and unable to access data stored thereon (64). However, a positive response to the test at step (54) will result in the new server node working on data provided by the master disk (56). Thereafter, the new server node requires data that is stored on a data set in a second storage media within an area of the storage area network assigned to the cluster in order to perform a specific function (58). Prior to accessing the data set on the second storage media, a test is conducted to determine if the new server node is compatible with the disk header of the second storage media (60). A negative response to the test at step (60) will result in a denial of access of the new server node to the data set stored on the second storage media due to incompatibility (62). However, a positive response to the test at step (60) will result in the new server node working on the data set stored on the second storage media (64). During the process at step (64), it may be determined that the new server node requires data that is stored on the second storage media in a prior software version (66). The new server node requests access to the required data (68). A test is then conducted to determine if the file attributes of the required data is compatible with the software operating on the new server node (70). A positive response to the test at step (70) determines that the software operating on the new server node is compatible with the file attributes of the requested data (72), and the server node may then proceed with processing the requested data. However, a negative response to the test at step (70) will result in a denial of access to the requested data for the new server node (62). Accordingly, FIG. 2 illustrates the checks and balances of the prior art system for determining compatibility of a new server node with a storage area network and data stored therein subsequent to the server node becoming a member of the cluster.

There are several shortcomings associated with the prior art method for cluster membership. If it is determined that the new server node is incompatible with the data, either at steps (60) or (70), the server node is denied access. However, this is not indicative as to whether the server node has already initiated a process that it is now unable to complete because of an incompatibility that may have developed subsequent to the initial access of the data. This may result in wasting of time by starting a process on a portion of data that cannot be completed. Alternatively, the server node may have started a process and may be unable to reverse the work already completed, which would result in corrupted data. Accordingly, the prior art system for determining server and shared resource compatibility is inefficient and unreliable in assuring compatibility between the server node and data within the shared resource.

There is therefore a need for a method and system to avoid initiating an action that would be prematurely terminated based upon incompatibility of a server node with a shared resource.

### SUMMARY OF THE INVENTION

This invention comprises a method and system to determine compatibility between a server node and a shared resource.

In one aspect of the invention, a method is provided for controlling interoperability of members of a cluster. A version control record comprising all versions of each type of data structure in a shared resource is created. Software compatibility of a new cluster member with each data structure is validated, using the version control record, prior to a new cluster member joining the cluster.

In another aspect of the invention, a computer system is provided with at least two nodes adapted to operate in a computer cluster. A version control record is provided in a shared resource of the cluster. The version control record is inclusive of all versions of each type of data structure in the shared resource. In addition, a membership manager is provided to validate compatibility of a new cluster member with each data structure, with use of the version control record, prior to acceptance of the new cluster member.

In yet another aspect of the invention, an article is provided with a computer-readable signal-bearing medium. Means in the medium are provided for a version control record inclusive of each type of data structure in a shared resource. In addition, means in the medium are provided for validating compatibility of a new cluster member with each data structure in the shared resource, using the version control record, prior to joining the cluster.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a block diagram of server nodes in communication with a storage area network.

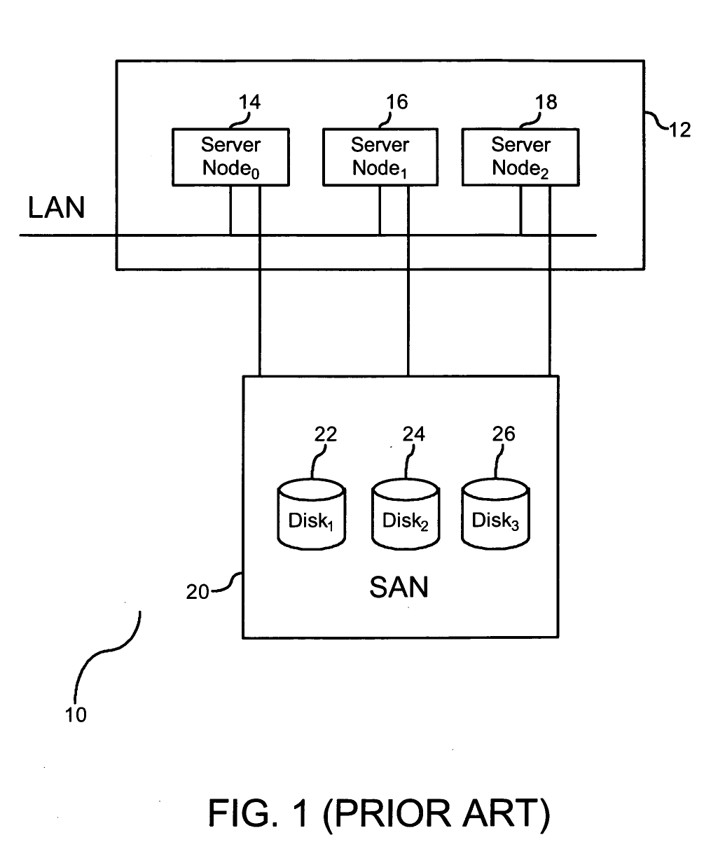

FIG. 2 is a prior art flow chart to determine compatibility between a cluster member and a shared resource.

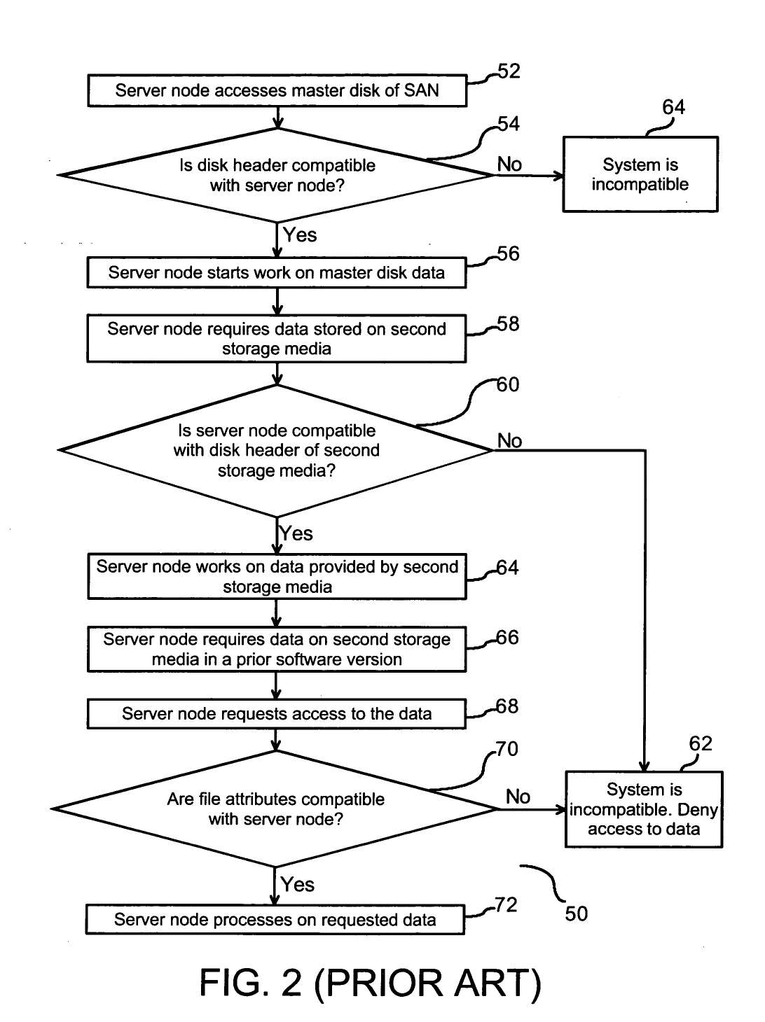

FIG. 3 is a flow chart illustrating the version control system according to the preferred embodiment of this invention, and is suggested for printing on the first page of the issued patent.

### DESCRIPTION OF THE PREFERRED EMBODIMENT

### Overview

A summary of the data structure version of each type of persistent data item, known as a version control record, is retained in a known location in a storage area network assigned to a cluster of server nodes. The version control record organizes meta data, which is defined as data or information about other data. The version control record is accessible by all members of the cluster. Prior to joining the cluster, a server node may scan the version control record to expeditiously determine it's compatibility with data maintained in persistent storage for the cluster. Accordingly, the version control record enables a server node to determine if membership with the cluster is optimal based upon shared resource data compatibility prior to joining the cluster.

### Technical Details

In a distributed computing system, multiple server nodes are in communication with a storage area network which functions as a shared resource for all of the server nodes. The storage area network may include a plurality of storage media. A version control system is implemented to insure that a server node requesting or considering membership in a cluster is compatible with the storage media of the storage area network assigned to the cluster, as well as the data structures within the storage media.

The version control system manages validation of compatibility of a requesting node prior to completion of the cluster membership process. One part of the version control system includes a disk header record which is maintained within each shared resource of the cluster. Each disk in the storage area network includes a disk header version associated therewith. The disk header record functions to organize and manage a storage area network with multiple storage disks and/or media. At an initial stage of cluster membership of a new server node, it is important to determine if the disk header of the master disk in the storage area network is compatible with the software operating on the requesting server node. Since the master disk houses a version control record of the version control system, it is important to determine if the requesting node is compatible with the disk header version of the master disk. Accordingly, the disk header version is determinative of accessibility of the requesting server node to the master disk of the storage area network.

As noted above, the version control system is comprised of two primary components, a disk header record and a version control record. In order to determine compatibility of a server node requesting membership in a cluster, a version control record in the form of a data structure is created to maintain information about the versions of all data structures within a shared resource of the cluster. The version control record is preferably maintained in non-volatile memory, and is available to all server nodes that are members of the cluster as well as any server node that wants to join the cluster. Each data structure in the shared resource is permanently assigned a position within the version control record. If the data structure becomes retired, the position for that data structure within the version control record remains. This prevents a future software version from using that position for a different data structure version. The misuse of a retired data structure position could lead to the older software version making an incorrect decision pertaining to incompatibility. Accordingly, the version control record maintains a master record of all data structures within the shared resource of a cluster.

In addition, the version control record maintains a version table of all versions of each data structure type in the shared resource of the cluster within the version control record. At the time of installation of the version control record in conjunction with the associated version table, each data structure type will have an initial assignment. A data structure may contain information about a file, such as it's size, creation time, owner, permission bits, and a version number associated with the operating system and/or software utilized at the time of creation. At such time as the format of this data structure changes, the associated version number in the version table will change as well. Accordingly, the version table will retain information for the data structure associated with both the version number at the time of creation, as well as the version number associated with the format change of the data structure.

When an upgrade to software operating on each of the server nodes is conducted, this process is uniform across all server nodes in the cluster. New versions of software introduce changes to one or more of the data structures in the area of the storage area network assigned to the cluster. At such time as the software upgrade is complete across each of the server nodes in the cluster, the version table will be updated to include any new versions of each data structure, while retaining the previous version of the data structure. The version table functions as a resource for a prior software version of the data structure if there should be any issues at a later time that arise between the software upgrade and the previous versions of data structures. Accordingly, the version table retains records of versions of the software used to create and/or edit the data structures of the shared resource.

At such time as all of the data structures retained in the shared resource are converted to a new version number, the version control record may cease referencing the original or previous version number of the data structure. A server node running a particular software version may determine whether any data conversion is necessary in order to migrate the system from a previous software version to the current software version by referencing the version table of the version control record. Accordingly, the version control record maintains a version table to reference each of the data structures in the shared resource and the version under which the associated data structure is maintained.

The version control record also maintains a node table referencing the software versions operating within the member server nodes of the cluster. This table assures that all nodes are running identical software versions when data conversion for an upgrade is commenced. The node table may be stored in persistent memory to allow consideration of both active and inactive server nodes. Accordingly, the node table may be utilized to manage upgrades to system resources for both active and inactive cluster members.

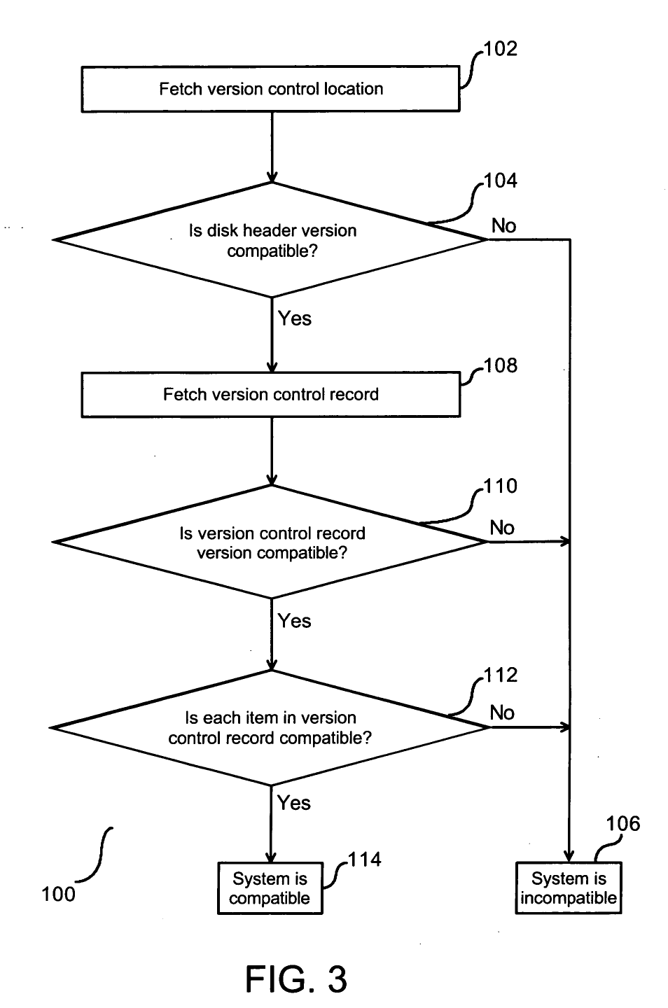

FIG. 3 is a flow chart (100) illustrating the process of a server node joining a cluster according to one embodiment of the present invention. Prior to joining the cluster, the server node requesting membership will initially review compatibility with data maintained in a shared resource of the cluster. The first step in this process is to determine the location of the version control record for the shared resource (102). The version control record is maintained at a known location and is a part of the configuration information for the cluster. Following determination of the location of the version control record, a test is conducted to determine if the server node considering membership in the cluster is compatible with the disk header of the master disk of the shared resource (104). This test entails the server node attempting to access the master disk by reading the disk header within the area of the storage area network assigned to the cluster. A negative response to the test at step (104) will result in a determination of incompatibility and the server node considering cluster membership will be denied membership in the cluster since it is not able to access data in the area of the storage area network assigned to the cluster (106). A determination of incompatibility will result in a notification to the system operator indicating the details of the incompatibility. Following step (104), such a notification will pertain to incompatibility with the disk header of the master disk of the shared resource. However, a positive response to the test at step (104) will result in locating and accessing the version control record (108). Thereafter, a subsequent test is conducted to determine if the server node considering membership is compatible with the version control record version (110). A negative response to the test at step (110) will result in a determination of incompatibility and the server node considering cluster membership will be denied (106) membership in the cluster. A notification is sent to the operator indicating the details of the incompatibility due to incompatibility with the version control record version. However, a positive response to the test at step (110) will result in a subsequent test to determine if each data structure in the version control record is compatible with the software operating on the server node considering membership in the cluster (112). A negative response to the test at step (112) will result in a determination of incompatibility and the server node considering cluster membership will be denied membership in the cluster (106). A notification is sent to the operator indicating the details of the incompatibility when the version control record indicates incompatibility between one or more data versions and the software running on the server node. However, a positive response to the test at step (112) will result in a determination that the entire shared resource is compatible with the server node requesting membership (114). Following step (114), the server node considering membership may proceed with cluster membership as compatibility between the server node and the shared resource and data therein has been established. Accordingly, the steps shown above illustrate how a server node requesting cluster membership will insure compatibility with the system prior to joining the cluster.

### Advantages Over The Prior Art

The version control system enables a server node to determine compatibility with shared resources in a cluster prior to joining the cluster. The system enables efficient use of resources to a joining member as well as existing cluster members. The information maintained in the version control system may be used to prevent an upgrade of data structures in the shared resource when all members of the cluster are not running compatible or identical software versions. In addition, a server node considering membership in the cluster has three opportunities to determine system compatibility prior to committing resources to joining the cluster. Accordingly, the version control system is a screening tool for cluster membership compatibility as well as a control mechanism for upgrades to system resources for existing cluster members.

### Alternative Embodiments

It will be appreciated that, although specific embodiments of the invention have been described herein for purposes of illustration, various modifications may be made without departing from the spirit and scope of the invention. In particular, the shared resource may be in the form of a storage area network with a plurality of storage media, or it may be in the form of shared memory. Additionally, information in the version control system may be used by a system administrator as a summary of the versioning state of the persistent data. Also, in the event incompatibility is determined at any stage in the control system, a notification may not be provided to the system operator. A notification may be in the form of a report or a message detailing reasons for failure of the server node to join the cluster. Such a report may include detailing information pertaining to an area in which a server node may require an upgrade. Accordingly, the scope of protection of this invention is limited only by the following claims and their equivalents.

1. A method of controlling interoperability of members of a cluster, comprising:
(a) creating a version control record comprising all versions of each type of data structure in a shared resource; and
(b) validating software compatibility of a new cluster member with each data structure using the version control record prior to a new cluster member joining said cluster.

2. The method of claim 1, further comprising scanning a data structure type record within said shared resource prior to accessing said version control record.

3. The method of claim 1, wherein the step of validating software compatibility of a new cluster member includes scanning said version control record for a data structure version conflict.

4. The method of claim 1, further comprising maintaining a table within said version control record of an operating software version of each node in said cluster.

5. The method of claim 4, further comprising validating compatibility of each node in said cluster with said operating software version table prior to upgrading each data structure in said shared resource.

6. The method of claim 5, wherein the step of validating compatibility of each of said nodes in said cluster is inclusive of inactive cluster nodes.

7. The method of claim 1, wherein said shared resource is selected from a group consisting of: a storage area network, and shared memory.

8. A computer system, comprising:
at least two nodes adapted to operate in a computer cluster;
a version control record in a shared resource of said cluster;
said version control record inclusive of all versions of each type of data structure in said shared resource; and
a membership manager adapted to validate compatibility of a new cluster member with each of said data structure with use of said version control record prior to acceptance of said new cluster member.

9. The system of claim 8, further comprising an operating software version table within said version control record.

10. The system of claim 9, further comprising a validation manager adapted to validate compatibility of an existing cluster member with said operating software version table prior to an upgrade of each data structure in said shared storage.

11. The system of claim 10, wherein said validation manager is inclusive of inactive cluster nodes.

12. The system of claim 8, further comprising a version manager adapted to scan a data structure type record within said shared resource prior to access of said version control record by a cluster member.

13. The system of claim 8, wherein said shared resource is selected from a group consisting of: a storage area network, and shared memory.

14. An article comprising:
a computer-readable signal-bearing medium;
means in the medium for a version control record inclusive of each type of data structure in a shared resource; and
means in the medium for validating compatibility of a new cluster member with each data structure in said shared resource using said version control record prior to joining said cluster.

15. The article of claim 14, wherein the medium is selected from a group consisting of: a recordable data storage medium, and a modulated carrier signal.

16. The article of claim 14, further comprising means in the medium for validating compatibility of each cluster member prior to upgrading each data structure in said shared resource.

17. The article of claim 16, wherein said compatibility validation means is an operating software version table within said version control record.

18. The article of claim 16, wherein said compatibility validation means includes inactive cluster nodes.

19. The article of claim 14, further comprising means in the medium for scanning a data structure type record prior to access of said version control record.

20. The article of claim 14, wherein said shared resource is selected from a group consisting of: a storage area network, and shared memory.
